(19) United States
(12) Patent Application Publication
(10) Pub. No.: US 2011/0071842 A1
(43) Pub. Date: Mar. 24, 2011

(54) JUDICIAL CASE MANAGEMENT COMPUTER SYSTEM AND METHOD FOR PROVIDING THE SAME

(75) Inventors: Sue HUMPHREYS, Rotonda West, FL (US); Paul WIESER, Boardman, OH (US)

(73) Assignee: COURTVIEW JUSTICE SOLUTIONS, North Canton, OH (US)

(21) Appl. No.: 12/888,882

(22) Filed: Sep. 23, 2010

Related U.S. Application Data
(60) Provisional application No. 61/244,995, filed on Sep. 23, 2009.

(51) Int. Cl. G06Q 50/00; G06Q 10/00

(52) U.S. Cl. 705/1.1

(57) ABSTRACT

A judicial case management computer system and a method for providing the same are provided. The judicial case management computer system includes storage. A set of differentiated case management (“DCM”) tracks are stored in the storage. Each of the DCM tracks represents a case type. The DCM tracks include a set of triggering events and a set of DCM elements consequential to the triggering events. A set of business rules corresponding with each of the DCM elements is provided. The set of business rules specify at least one condition for the DCM element. Computer-executable instructions are stored in the storage. The computer-executable instructions implement software when executed on the computer system for receiving a notification of the occurrence of one of the triggering events for a case, identifying the DCM elements corresponding to the one triggering event, and processing the identified DCM elements in accordance with the set of business rules for the DCM elements.

This application claims priority from U.S. Provisional Patent Application No. 61/244,995 filed on Sep. 23, 2009, the contents of which are incorporated herein by reference.

### FIELD OF THE INVENTION

The present invention relates generally to information systems. In particular, the invention relates to a method and system for providing a judicial administration system.

### BACKGROUND OF THE INVENTION

All courts have a defined sequence of steps that are necessary for the parties to take before a case comes is finally disposed. Generally speaking, the statutes of the courts define deadlines in which the steps must be taken. There may be interlocutory proceedings to deal with issues in the conduct of the case that require the use of judicial resources. Further, each court can have established local process requirements as a result of local management decisions. That is, a particular court can set out periods of time during which a judge will hear certain types of motions, cases, etc. For example, a particular court can establish, either informally or formally, that it will hear new emergency motions at 7:30 am every morning, or that it will, every Tuesday, hear family law cases between 9:00 am and 12:00 pm and child custody cases between 1:00 pm and 4:30 pm.

In order to ensure that cases proceed expeditiously through the courts, it is necessary to ensure that parties adhere to the deadlines set out in the rules and local process requirements. Further, it is also important that the necessary judicial resources are available to address issues that require the attention of the court. Judicial resources include venues, such as courtrooms and mediation rooms, personnel, such as judges, court officers and court clerks, and equipment.

It is therefore an object of the invention to provide a novel judicial case management computer system and a method for providing the same.

### SUMMARY OF THE INVENTION

According to an aspect of the invention, there is provided a judicial case management computer system, comprising:

storage;

a set of differentiated case management (“DCM”) tracks stored in said storage, each of said DCM tracks representing a case type, said DCM tracks comprising a set of triggering events and a set of DCM elements consequential to said triggering events;

a set of business rules corresponding with each of said DCM elements, said set of business rules specifying at least one condition for said DCM element;

computer-executable instructions stored in said storage, said computer-executable instructions implementing software when executed on said computer system for receiving a notification of the occurrence of one of said triggering events for a case, identifying said DCM elements corresponding to said one triggering event, and processing said identified DCM elements in accordance with said set of business rules for said DCM elements.

The computer system can include resource information stored in the storage, the resource information identifying resources employed to fulfill the DCM elements. The resource information can include information about personnel. The resource information can include role information for the personnel. The resource information can include information about venues.

The computer system can include a set of values corresponding to the sets of business rules, the values modifying the business rules.

The DCM tracks can specify the order of events for a case.

The DCM tracks can be instantiated from a DCM track template.

The DCM elements can include one or more of events, notifications, responses to notifications, incoming information, outgoing information, actions, time allowances between DCM elements and expiry boundaries, and target dates/periods.

At least some of said business rules can specify completion requirements for the DCM elements.

At least some of the business rules specify permissibility requirements for the DCM elements.

At least some of the business rules can specify if the DCM elements are necessary or optional.

Portions of the DCM tracks and business rules can be modified.

A system administrator can establish portions of the DCM tracks and business rules that are unmodifiable.

According to another aspect of the invention, there is provided a method for providing a judicial case management computer system, comprising:

storing a set of differentiated case management (“DCM”) tracks stored in storage of a computer system, each of said DCM tracks representing a case type, said DCM tracks comprising a set of triggering events and a set of DCM elements consequential to said triggering events;

storing a set of business rules corresponding with each of said DCM elements, said set of business rules specifying at least one condition for said DCM element;

receiving a notification of the occurrence of one of said triggering events for a case;

identifying said DCM elements corresponding to said one triggering event; and

processing said identified DCM elements in accordance with said set of business rules for said DCM elements.

According to a further aspect of the invention, there is provided a method for providing judicial case management, comprising:

receiving a notification of the occurrence of a triggering event for a case;

identifying DCM elements corresponding to said one triggering event in a DCM track for the case type of said case stored in storage of a computer system; and

processing said identified DCM elements in accordance with a set of business rules corresponding to said DCM elements.

### BRIEF DESCRIPTION OF THE DRAWINGS

An embodiment will now be described, by way of example only, with reference to the attached Figures, wherein:

FIG. 1 shows a high-level architecture of a judicial case management computer system in accordance with an embodiment of the invention and its operating environment;

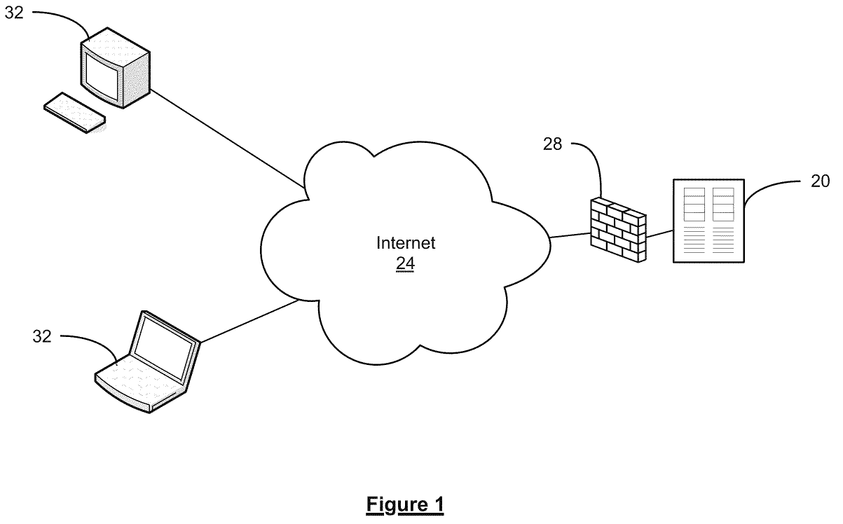

FIG. 2 shows a schematic diagram of the computer system of FIG. 1;

FIG. 3 shows a number of software and data components of the computer system of FIG. 1;

FIG. 4 shows a number of events and actions for an exemplary case and related triggered elements represented by a DCM track used by the computer system of FIG. 1; and

FIG. 5 is a flowchart of the general method of processing a triggering event employed by the computer system of FIG. 1.

### DETAILED DESCRIPTION OF THE EMBODIMENT

A judicial case management computer system 20 in accordance with an embodiment of the invention is shown in communication with a large, public network, such as the Internet 24 via a firewall 28. The judicial case management computer system 20 is located centrally for a jurisdiction. The firewall 24 controls access to the judicial case management computer system 20. A pair of client computing devices 32 are shown coupled to the Internet 24. The client computing devices 32 are used by various judicial officers and court staff at any of the court locations for the jurisdiction to communicate with the judicial case management computing system 20 to access the functionality provided thereby.

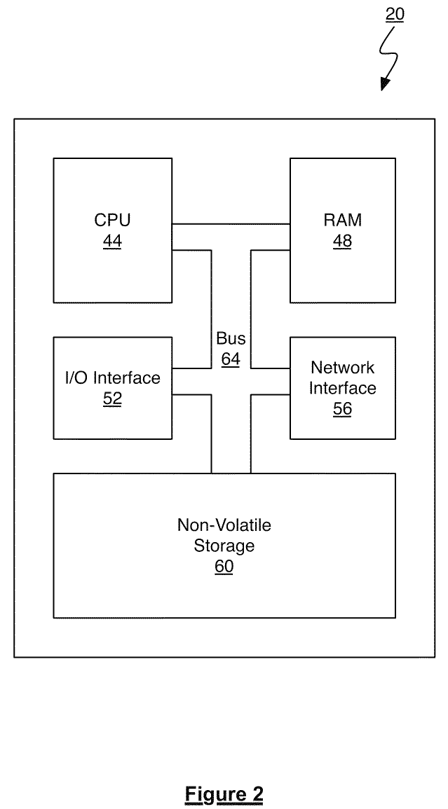

FIG. 2 shows various physical elements of the computer system 20. As shown, the computer system 20 has a number of physical and logical components, including a central processing unit (“CPU”) 44, random access memory (“RAM”) 48, an input/output (“I/O”) interface 52, a network interface 56, non-volatile storage 60, and a local bus 64 enabling the CPU 44 to communicate with the other components. The CPU 44 executes an operating system and computer-executable instructions for implementing a judicial case management software platform as will be described. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network interface 56 enables communication with other systems. Non-volatile storage 60 stores the operating system, the computer-executable instructions for implementing the judicial case management software platform and data stored and used by the judicial case management software platform. During operation of the computer system 20, the operating system, the computer-executable instructions for implementing the judicial case management software platform and the data may be retrieved from the non-volatile storage 60 and placed in RAM 48 to facilitate execution and access.

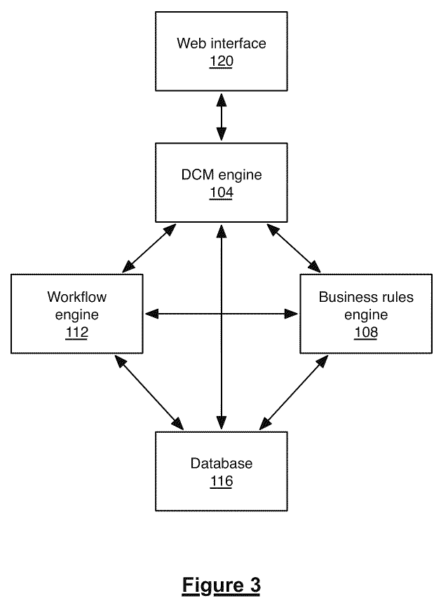

FIG. 3 shows various software and data components of the judicial case management software platform executed by the computer system 20. A differentiated case management (“DCM”) engine 104 is in communication with a business rules engine 108, a workflow engine 112 and a database 116. The client computing devices 32A can interact with the DCM engine 104 via a web interface 120.

The DCM engine 104 is event-driven, acting as a central point for scheduling DCM elements, such as certain case activities, and guiding the processing and lifecycle of cases. A case is treated as a container for one or more incidents or legal matters, or a mixture thereof. Differentiated case management refers to case processing that includes at least one manual or automated event that triggers the case for processing down one process flow over others. The DCM engine 104 manages cases from creation to disposition in this manner. The DCM elements themselves are not differentiated case management, but rather differentiated case management is the organization, coordination, and scheduling of these DCM elements.

The business rules engine 108 manages discrete sets of business rules for each DCM element in the form of extensible and re-usable logic stored in the database 116, and provides results of the evaluation of these rules to the DCM engine 104. These results may result in further processing and/or calls to the workflow engine 112 for the case.

The database 116 stores DCM tracks and case history details for each case, as will be described below. In addition, the database 116 stores values, referred to as “magic values”, and resource information. Resource information can include the availability of any personnel, venues and equipment. Further, the resource information includes the roles assigned to each person. The resource information enables the workflow engine 112 to assign tasks to the correct personnel. The resources and their availability are configured via a separate user interface.

### DCM Tracks

At the heart of the judicial case management computer system 20 is the DCM track. A DCM track is a set of coordinated and dependent DCM elements that define the various activities that can occur in the differentiated case management lifecycle of a case for a particular case type, as well as any timing and resource information for the DCM elements. The DCM engine 104 implements DCM tracks via the following parts:
DCM tracks defined for different case types and time schedules stored in the database 116;
sets of business rules stored by the business rules engine 108; and
parameters for the DCM tracks and business rules, referred to as “magic values”, stored in the database 116.

Each case type or group of case types handled by the computer system 20 has at least one associated DCM track. These DCM tracks define the lifecycle of the business rules and automated processing available to electronically manage the case. DCM tracks chain together a set of one or more DCM elements that can and/or need to occur on a case. These DCM elements may be required as a result of statutes, rules or as a result of local processing requirements established via management decisions specific to a particular court. DCM elements are triggered and have associated business rules. Examples of DCM elements are events, notifications, responses to notifications, incoming information, outgoing information, actions, time allowances between elements and expiry boundaries, and target dates/periods. Any DCM element may have its own data, attachment and authorship signature. In other words, each DCM element can have its own diverse set of input and output, including data, attachments, and possibly other unique attributes such as an authorized signature. DCM elements can be re-used across DCM tracks and even within a single DCM track. For example, a motion ruling can occur more than once in the lifetime of a case.

DCM tracks may also contain phases bordered by “gates” that may coincide with one or more DCM elements. Time allowances and expiry boundaries may apply to phase boundaries and DCM elements. These time allowances, expiry boundaries, etc. are specified using magic values stored in the database 116. The phases are defined by the court. Each court may define the gates between the phases differently, and possibly the phases themselves differently.

The business rules engine 108 uses discrete code blocks (business rules) and Drools, an open-source business rules management system, in order to equip the DCM engine 104 and the workflow engine 112s with logic and evaluation of variables. More information about Drools can be found at http://www.jboss.org/drools/, the contents of which are incorporated herein by reference. The sets of business rules correspond to DCM elements and are invoked when the DCM engine 104 is processing or planning a particular DCM element. For example, the DCM engine 104 can use sets of business rules to determine if a DCM element such as a submission has been completed satisfactorily. In this case, the business rules specify the particular conditions for completion. Where the DCM engine 104 is planning a future DCM element such as a hearing, the business rules can specify what the conditions are for scheduling the hearing. Similar DCM elements across different DCM tracks and even the same DCM tracks can share the same set of business rules, but can be differentiated based on the case attributes, resource attributes, local regulations, and procedural “magic values” that stipulate the specific conditions and time constraints.

Using the computer system 20, a case is processed along the logical sequence of triggers, events, notifications, responses to notifications, incoming information, outgoing information and activities, as well as within time allowances and expiry boundaries defined by the DCM track for that case type. If the logical sequence and the time standards are the same for two cases, they both follow a single DCM track. Typically, however, there are multiple DCM tracks even for similar types of cases. For example, while two case types may follow the same logical sequence, they may correspond to different DCM tracks, such as a “normal” and an “expedited” DCM track. The differences between these two DCM tracks are entirely expressed within the associated DCM template, business rules and magic values for the time limits allowed. Where case types follow two sets of logical sequences and have two definitions of time standards, a total of four DCM tracks are used to represent the logical sequence of events and time standards.

Planned case track data and case details are stored in the database 116. The planned case track data corresponds to projected DCM track elements for the case after adjustment for real-world events. The case details are the actual registered events/activities/etc. for a case.

DCM tracks can have eligibility constraints that define when the DCM tracks are effective from, what they cover, when they are effective until, etc. These constraints can also extend down to the individual rule and/or magic value level.

DCM is invoked upon an action of a human user, an action of an (external) application or system, the execution of some process within the system, and the lapse of time. In the first scenario, the creation of a docket entry by a user can cause the DCM engine 104 to examine the DCM track for the particular case to determine what DCM elements may be triggered as a result of the docket entry. In the second scenario, a notification of a new, relevant item of information from a motor vehicle bureau can trigger revisions to future events within a DCM track. The passage of time can cause the DCM engine 104 to send notifications upon the expiration of an allowable time period for the performance of a task by a party in a case.

At runtime, the DCM engine 104 governs which actions (events, reminders, ticklers, incoming and outgoing information, subscriptions and notifications) are:
permissible vs. not permissible, depending on the status of the legal matter in its respective life cycle;
optional vs. necessary, based on applicable statutes, rules and local management decisions; and
recommended or suggested, based on local management decisions.
   These conditions are stored in the associated set of business rules.

The processing of DCM elements by the DCM engine 104 for a particular case causes the DCM engine 104 to call the business rules that apply to the DCM elements within the DCM track that governs the type of the particular case, and trigger and/or schedule the appropriate judicial and non-judicial DCM elements while considering the availability of personnel and/or other resources that may be required to confirm, complete or execute these actions.

In a very simple example, if a court requires the scanning of a citation/complaint, the DCM track may define that the citation should be scanned within the first ten days of the citation being received by the court. Based on the configured desires of the court, the DCM track may be set up with a tickler for a person or group of people to remind them, and/or place an event in the computer system 20 for that case, indicating that the scanning of the citation should take place by a particular date. Although related, a tickler and an activity are not the same thing. A tickler is a reminder to humans to do something, the other is a record of the thing itself, whether completed or not.

Examples of activities found in DCM tracks include:
entering a citation/complaint into the computer system 20;
correcting any validation errors of the citation;
holding a hearing;
receiving a document or information;
sending a document or information;
alerting/notifying the system or a human user;
assigning a citation a case number;
scheduling an initial hearing;
assigning a judge; and
scheduling a trial.

The magic values stored in the database 116 are parameters, criteria, and other values used by the DCM engine 104 in its management of a case. In the example above, including a rule to scan a citation within ten days of the receipt of the citation, “ten,” “days,” and “Citation Received Date” are all magic values stored by the computer system 20 in association with the activity of scanning a citation. These values are completely configurable by individual courts and are used by the business rules in the execution of the DCM.

The DCM engine 104 uses the set of business rules in the business rules engine 108 for the DCM track associated with the case in question to evaluate criteria and determine the correct management path for a case. Sets of business rules are identified within DCM tracks for the various situations and conditions potentially encountered by cases. The DCM engine 104 gathers all the necessary data required by the business rules engine 108, including any magic values. These rules define the way in which to handle cases under these various situations. The DCM engine 104 gathers up all the magic values required, along with all the relevant case data, determines which rules to call, calls the business rules engine 108 with all this information, then, based on the results back from the business rules engine 108, processes the case accordingly.

The workflow engine 112 is concerned with the execution of elements that are specified by the applicable DCM track, using the available resources, such as judicial officers and court staff, venues and equipment. Judicial officers and court staff are assigned roles defined for the computer system 20. Different roles are defined within the computer system 20 having different responsibilities and authority to perform certain tasks. Judicial officers and court staff are assigned roles during configuration of the computer system 20 to allow the workflow engine 112 to allocate tasks and authorities to the personnel. The workflow engine 112 uses personnel, venue and equipment availability information provided, together with the roles assigned to the personnel, to match up the requirements for DCM elements with judicial officers and court staff, venues and equipment. For example, the next DCM element for a particular case may be a hearing. The workflow engine 112 is able to determine which personnel are required for the hearing, check the availability of the personnel and schedule the hearing accordingly.

The workflow engine 112 allocates the work required, based on resource schedules, business rules and the elements that are required by DCM. The workflow engine 112 considers both DCM and activities that may be consequential to allowed user input; e.g., the specification of a task to be carried out. The workflow engine 112 tracks actual work performed against the DCM track and uses local settings to manage work completion tracking and escalations. Notifications and subscriptions to work items and complete-work events are also handled by the workflow engine 112.

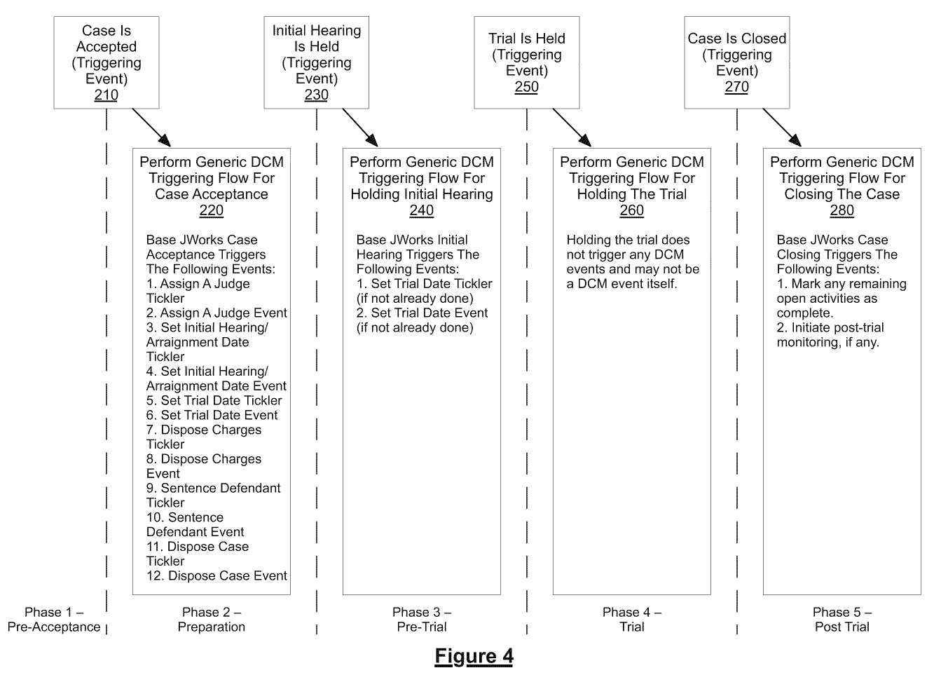

FIG. 4 illustrates a set of triggering events and corresponding DCM elements specified by a DCM track for a generic criminal case. A case's lifetime commences, and thus the DCM track starts, with the acceptance of a triggering event (210). A criminal case-starting action can be the receipt by the court of a complaint. This may be a law enforcement agency notifying the court of an arrest or the filing of a complaint by a legal entity such as an individual or a company. For traffic violations, it may be the receipt of a citation. Upon the creation of the case via a docket entry in the judicial case management computer system 20 by a judicial offer or other court staff member, the DCM engine 104 retrieves the DCM track corresponding to the case type. All case filings have certain validation requirements that must be satisfied before they are accepted by the court. These range from something as simple as “The defendant must have a name,” to other, jurisdiction-specific rules, such as “This court doesn't deal with juveniles.” The court cannot process this filing without all the required information. These conditions are codified in the business rules associated with the triggering event.

The DCM engine 104 then performs generic DCM triggering flow for case acceptance (220). In particular, the DCM engine 104 retrieves the DCM track corresponding to the case type from the business rules engine 108 and processes each DCM element corresponding to the triggering event specified by the DCM track. As shown, the triggered DCM elements include ticklers for assigning a judge to the case, setting an initial hearing/arraignment date and a trial date, disposing the charges, sentencing the defendant and disposing the case. In addition, the triggered DCM elements also include events for the assignment of a judge, the setting of the initial hearing/arraignment date, the setting of the trial date, the disposing of the charges, the sentencing of the defendant and the disposing of the case. Each of these DCM elements have an associated set of business rules that specify, for example:
what role of personnel receives the tickler;
when events have to be scheduled by;
what personnel (such as a judge) to assign;
the statutory time period during which something must be done (e.g. “This type of case must be disposed of within 60 days of filing.”);
resources required (such as an interpreter, a translator or a wheelchair);
what documents have to be sent out when; and
which documents have to be received and by who (for example, “when the last reply to an answer is filed, by at least one of the petitioner, within 60 days from x”).

Logging of the docket entry indicating the case has been accepted moves the DCM track from a first phase of pre-acceptance to a second phase of case preparation.

When the initial hearing is scheduled and held, a docket entry is created in the computer system 20 (230). In response, the DCM engine 104 performs generic DCM triggering flow for holding the initial hearing (240). As shown, there are two DCM elements associated with this triggering event in the DCM track for this case: the setting of a trial date tickler and the setting of the trial date. Upon receiving the docket entry at 230, the DCM track moves into a third phase of pre-trial.

When the trial is scheduled and held, a docket entry is created in the computer system 20 (250). In response, the DCM engine 104 performs generic DCM triggering flow for holding the trial (260). As shown, there are no DCM elements associated with this triggering event in the DCM track for this case. Upon receiving the docket entry at 250, the DCM track moves into a fourth phase of trial.

When the case is closed, a docket entry is created in the computer system 20 (270). In response, the DCM engine 104 performs generic DCM triggering flow for the closing of the case (280). As shown, there are two DCM elements associated with this triggering event in the DCM track for this case: the marking of any remaining activities as complete, and the initiating of any activities that are required after the trial, such as monitoring the defendant to make sure she or he adheres to the sentencing conditions. Upon receiving the docket entry at 270, the DCM track moves into a fifth phase of post-trial.

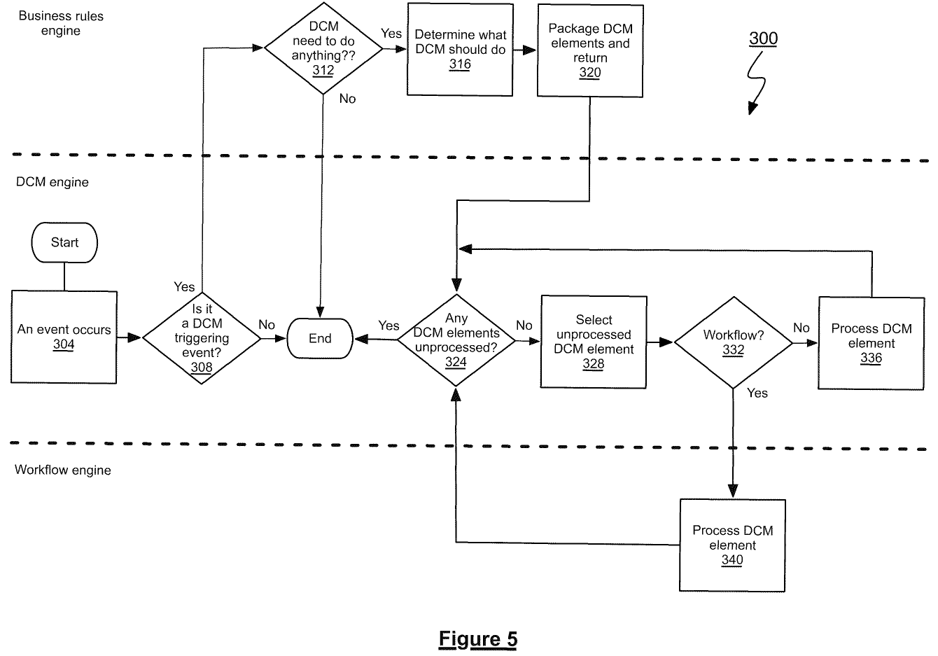

FIG. 5 is a flowchart of the method of processing an event by the DCM engine 104 generally at 300. The method 300 commences with the occurrence of an event (304). The judicial case management computer system 20 then determines if the event that occurred is a DCM event (308). A “DCM event” is an event that signifies something to the computer system 20 in that can trigger DCM elements. The DCM engine 104 determines if the event matches one of the defined events in the DCM track for the case type and potentially other criteria. For example, an event can be the placement of a note in the case. Often, such an event is inconsequential, in that it triggers no further actions. Another exemplary event is the receipt of a requested document, such as a motion for continuance or a request for a jury trial. In this case, ticklers and other business events can be generated as a result of the document being received. If the event that occurred is not a DCM event, then the DCM engine 104 determines that no further action needs to be taken and the method 300 ends. If, instead, the DCM engine 104 determines that the event that occurred is a DCM event, the DCM engine 104 then sends a request to the business rules engine 108 for a list of activities and events that have to be performed as a result of the DCM event. The request includes an identification of the event that occurred and the particular case, along with any other data that the business rules engine 108 might need, such as full case or person information, or certain magic values relevant to the event that just occurred or the events that might be triggered. In addition, the request includes the case history details, identifying what events have occurred, what ticklers have been created, etc. Upon receipt of the request, the business rules engine 108 determines if anything needs to be done on the DCM track for the case in question as a result of the event that occurred (312). In particular, the business rules engine 108 determines if any DCM elements are triggered by the DCM track. The business rules engine 108 then determines what it should direct the DCM engine 104 to do (316). During this determination, the business rules engine 108 determines, using the case history details, what tasks that need to be performed have already been performed. The business rules engine 108 then packages instructions and returns them to the DCM engine 104 (320).

Upon receiving the instructions from the business rules engine 108, the DCM engine 104 determines if there are any unprocessed DCM elements returned by the business rules engine 108 (324) If there are no unprocessed DCM elements from the business rules engine 108, the method 300 ends (i.e., there is nothing to for DCM to “do”). If, instead, the DCM engine 104 determines that there are DCM elements that require processing at 324, the DCM engine 104 selects an unprocessed DCM element (328). The DCM engine 104 then determines if the selected DCM element indicates to perform a workflow event (332) The selected DCM element may require resources to be allocated or notified, such as a tickler that notifies a particular judicial officer or court staff member. If the selected DCM element corresponds to a workflow event, the DCM engine 104 passes the DCM element to the workflow engine 112, which then performs the appropriate processing (340). After execution, the workflow engine 112 notifies the DCM engine 104 that the process is complete, and the DCM engine 104 determines if there are any remaining unprocessed DCM elements at 324. If, instead, the DCM engine 104 determines that the instruction does not relate to a workflow event at 332, the DCM engine 104 performs the appropriate processing of the DCM element (336), such as, for example, scheduling a bail hearing. After processing of the DCM element, the DCM engine 104 determines if there are any remaining unprocessed DCM elements at 324. This process continues until there are no remaining DCM elements to be processed.

### DCM Track Templates

A DCM track template comprises the collection of DCM tracks necessary to manage the caseload of a given court or group of courts, the workflow settings that enumerate the workforce census, individual and team roles and responsibilities and operational availability, the business rules that are associated with DCM and workflow elements and managed by the business rules engine 108, and requisite values.

A DCM track template typically initially corresponds to a base set of DCM tracks for a jurisdiction. A DCM track template provides baseline DCM functionality for all case types for a particular jurisdiction for which a system administrator can make setup/configuration changes as necessary to implement court-specific local processing requirements where such processes differ from the DCM track template. A DCM track template includes the following for each case type that is configured for the jurisdiction of the court:
DCM tracks for each case type which may be further specified by time schedule;
sets of business rules for each DCM element along each DCM track; and
magic values for the sets of business rules, as required.

DCM tracks for cases are instantiated from the DCM track template.

By installing a DCM track template on a judicial case management computer system 20, its behavior and function can be modified to correspond to the needs of another jurisdiction's court. The computer system 20 can be further customized for a particular court in a jurisdiction by pre-configuring the DCM tracks, DCM elements and magic values for the particular court before the DCM track template is applied to the computer system 20. Further, individual components (i.e., DCM tracks, business rules and magic values) can be replaced on the computer system 20 to modify its behavior.

DCM tracks offer inheritance. A standard DCM track for a particular case type can be differentiated by overriding a single trigger, event, notification, response to a notification, incoming information, outgoing information or activity, with another, single item or with multiple items, to constitute a second DCM track called “Exception”.

### Configuration

Prior to configuration, DCM tracks exist for the highest level of statutes and rules for each particular case type. Examples are a case management system (“CMS”) track for a state court, a prosecutor CMS track for a prosecutor in a different state, or a felony justice DCM track for felony incident(s) processing through yet another state's justice system. These DCM tracks can then be inherited from for local processing requirements by adding, overriding, and/or deleting elements, subject to statutes and rules that may govern the deletion and/or modification of certain elements.

The DCM engine 104 has a user interface for customizing DCM tracks in the DCM track template. Only elements that are permitted to be added and/or overridden can, in fact, be manipulated. The judicial case management computer system 20 allows for the specification of these requirements at the rule and/or processing level. System administrators in each jurisdiction maintain these specifications to prevent unauthorized changes. In this manner, the higher-level administration can enforce statute and rule compliance through the software, without restricting locally-valuable processing improvements and methods that are beneficial to one local administration but not another. An example would be the automatic use of an event on a local DCM track that isn't required by the global/parent DCM track. Any DCM element configured in a DCM track can have attributes such as allowed/not allowed, required or optional, suggested/not suggested, within the scope and the element sequence of that DCM. Again, this helps to enforce processing compliance from top to bottom, by assuring a base level of process, sequence and triage/process decision criteria.

Software behavior is governed by the DCM engine 104 and the workflow engine 112, using logic that is packaged and managed through the business rules engine 108 and data accessible to the judicial case management computer system 20, such as its database 116, documents inside and outside of the computer system 20, and external system. By using DCM track templates to customize the behavior of the judicial case management computer system 20, the computer system 20 is:
usable across judicial organizations that are subject to different statutes and rules;
usable across organizations that may be subject to the same statutes and rules but that are different in size, staffing, staff role definitions, staff responsibilities, physical layout of operations, front-office layout and division of labor, without requiring custom code to have the application queue up work items according to local work allocation requirements and based on the local statutes and rules;
implementable in single and multi-office environments, and at the same time be implementable in single and multi jurisdictional environments, with each setup respecting locally-applicable statutes, rules and local process configurations, without requiring custom code for each; and
able to start and switch behavior of the computer system 20, upon the (conceptual) insertion of a DCM track template.

The judicial case management computer system 20 adapts to the locally-applicable statutes and rules, without requiring custom code for each, by implementing DCM tracks that encode both local legal and management requirements.

DCM is used by the judicial case management computer system 20 to automate for the court as much mundane case management as possible. It is designed to relieve the worker from the task of making each and every decision on the management of a case, and then updating the computer system 20 accordingly. It is as configurable as possible, allowing for customization to meet the individual and possibly unique requirements of each court.

While the invention has been described with specificity to a certain configuration of functionality between the DCM engine 104, the business rules engine 108 and the workflow engine 112, other types of implementations will occur to those of skill in the art. For example, the business rules engine 108 can be made to govern the timing conditions of events in the DCM tracks.

As will be understood, a case can change DCM track in some cases. For example, if a case is on a standard schedule and is then expedited, it can be switched to the corresponding DCM track for expedited cases of that type.

Parameters used by the DCM tracks and business rules can be coded right into them instead of relying on external values.

Computer-executable instructions for implementing the judicial case management software platform on a computer system could be provided separately from the computer system, for example, on a computer-readable medium (such as, for example, an optical disk, a hard disk, a USB drive or a media card) or by making them available for downloading over a communications network, such as the Internet.

While the computer system is shown as a single physical computer, it will be appreciated that the computer system can include two or more physical computers in communication with each other. Accordingly, while the embodiment shows the various components of the judicial case management software platform residing on the same physical computer, those skilled in the art will appreciate that the components can reside on separate physical computers.

One or more portions of the method may be executed by third parties.

The above-described embodiments are intended to be examples of the present invention and alterations and modifications may be effected thereto, by those of skill in the art, without departing from the scope of the invention that is defined solely by the claims appended hereto.

What is claimed is:

1. A judicial case management computer system, comprising:
storage;
a set of differentiated case management (“DCM”) tracks stored in said storage, each of said DCM tracks representing a case type, said DCM tracks comprising a set of triggering events and a set of DCM elements consequential to said triggering events;
a set of business rules corresponding with each of said DCM elements, said set of business rules specifying at least one condition for said DCM element;
computer-executable instructions stored in said storage, said computer-executable instructions implementing software when executed on said computer system for receiving a notification of the occurrence of one of said triggering events for a case, identifying said DCM elements corresponding to said one triggering event, and processing said identified DCM elements in accordance with said set of business rules for said DCM elements.

2. The computer system of claim 1, further comprising:
resource information stored in said storage, said resource information identifying resources employed to fulfill said DCM elements.

3. The computer system of claim 2, wherein said resource information includes information about personnel.

4. The computer system of claim 3, wherein said resource information includes role information for said personnel.

5. The computer system of claim 3, wherein said resource information includes information about venues.

6. The computer system of claim 1, further comprising:
a set of values corresponding to said sets of business rules, said values modifying said business rules.

7. The computer system of claim 1, wherein said DCM tracks specify the order of events for a case.

8. The computer system of claim 1, wherein said DCM tracks are instantiated from a DCM track template.

9. The computer system of claim 1, wherein said DCM elements can include one or more of events, notifications, responses to notifications, incoming information, outgoing information, actions, time allowances between DCM elements and expiry boundaries, and target dates/periods.

10. The computer system of claim 1, wherein at least some of said business rules specify completion requirements for said DCM elements.

11. The computer system of claim 1, wherein at least some of said business rules specify permissibility requirements for said DCM elements.

12. The computer system of claim 1, wherein at least some of said business rules specify if said DCM elements are necessary or optional.

13. The computer system of claim 1, wherein portions of said DCM tracks and business rules can be modified.

14. The computer system of claim 13, wherein a system administrator can establish portions of said DCM tracks and business rules that are unmodifiable.

15. A method for providing a judicial case management computer system, comprising:
storing a set of differentiated case management (“DCM”) tracks stored in storage of a computer system, each of said DCM tracks representing a case type, said DCM tracks comprising a set of triggering events and a set of DCM elements consequential to said triggering events;
storing a set of business rules corresponding with each of said DCM elements, said set of business rules specifying at least one condition for said DCM element;
receiving a notification of the occurrence of one of said triggering events for a case;
identifying said DCM elements corresponding to said one triggering event; and
processing said identified DCM elements in accordance with said set of business rules for said DCM elements.

16. A method for providing judicial case management, comprising:
receiving a notification of the occurrence of a triggering event for a case;
identifying DCM elements corresponding to said one triggering event in a DCM track for the case type of said case stored in storage of a computer system; and
processing said identified DCM elements in accordance with a set of business rules corresponding to said DCM elements.
